(19) United States
(12) Patent Application Publication
(10) Pub. No.: US 2016/0325645 A1
(43) Pub. Date: Nov. 10, 2016

(54) CHILD HEAD STABILIZING SYSTEM

(71) Applicant: George Hansen, Fanwood, NJ (US)

(72) Inventor: George Hansen, Fanwood, NJ (US)

(21) Appl. No.: 14/706,946

(22) Filed: May 7, 2015

(51) Int. Cl. B60N 2/28; A42B 3/08

(52) U.S. Cl. CPC B60N 2/2851; A42B 3/08

(57) ABSTRACT

A child head stabilizing system includes a helmet to receive and be positioned on a head of a child. A securing member is attached to the helmet. A chair for holding the child has an apex. A connector is attached to the chair adjacent to the apex and is removably secured to the securing member to retain the helmet within a selected distance from apex.

### BACKGROUND OF THE DISCLOSURE

### Field of the Disclosure

The disclosure relates to head stabilizing devices and more particularly pertains to a new head stabilizing device for retaining a child's head in a generally upright position while the child sleeps in a vehicle.

### SUMMARY OF THE DISCLOSURE

An embodiment of the disclosure meets the needs presented above by generally comprising a helmet is configured to receive and be positioned on a head of a child. A securing member is attached to the helmet. A chair for holding the child has an apex. A connector is attached to the chair adjacent to the apex and is removably secured to the securing member to retain the helmet within a selected distance from apex.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a rear perspective view of a child head stabilizing system according to an embodiment of the disclosure.

FIG. 2 is a rear view of an embodiment of the disclosure.

FIG. 3 is a top view of an embodiment of the disclosure.

FIG. 4 is a side view of an embodiment of the disclosure.

FIG. 5 is a front in-use view of an embodiment of the disclosure.

### DESCRIPTION OF THE PREFERRED EMBODIMENT

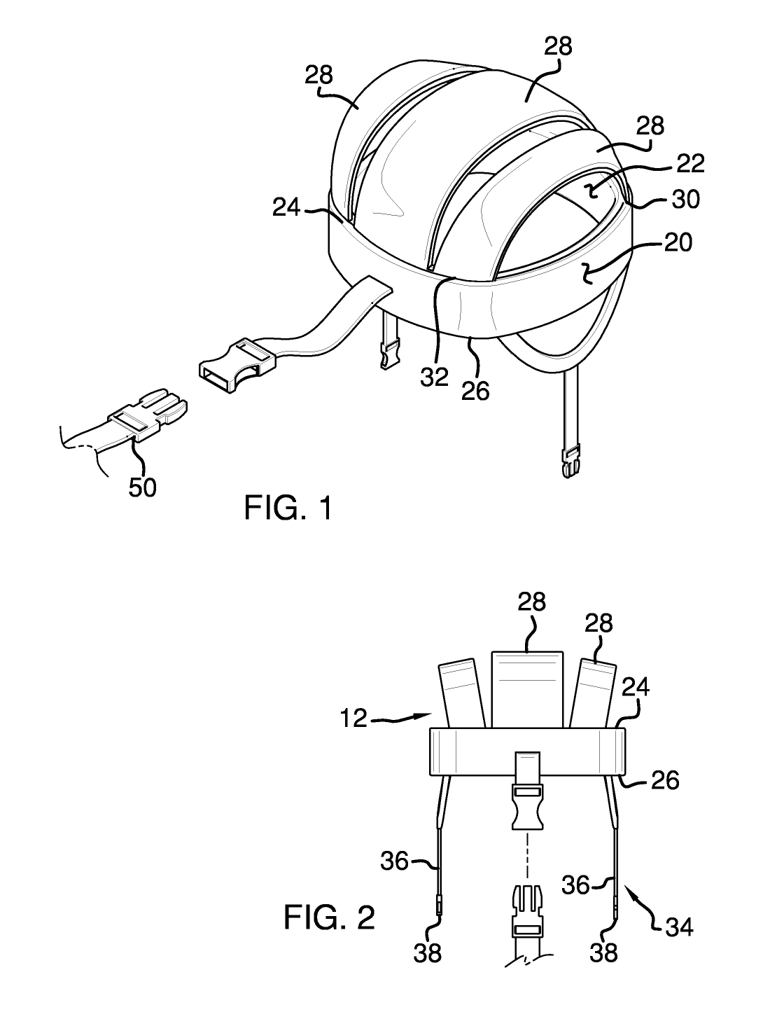

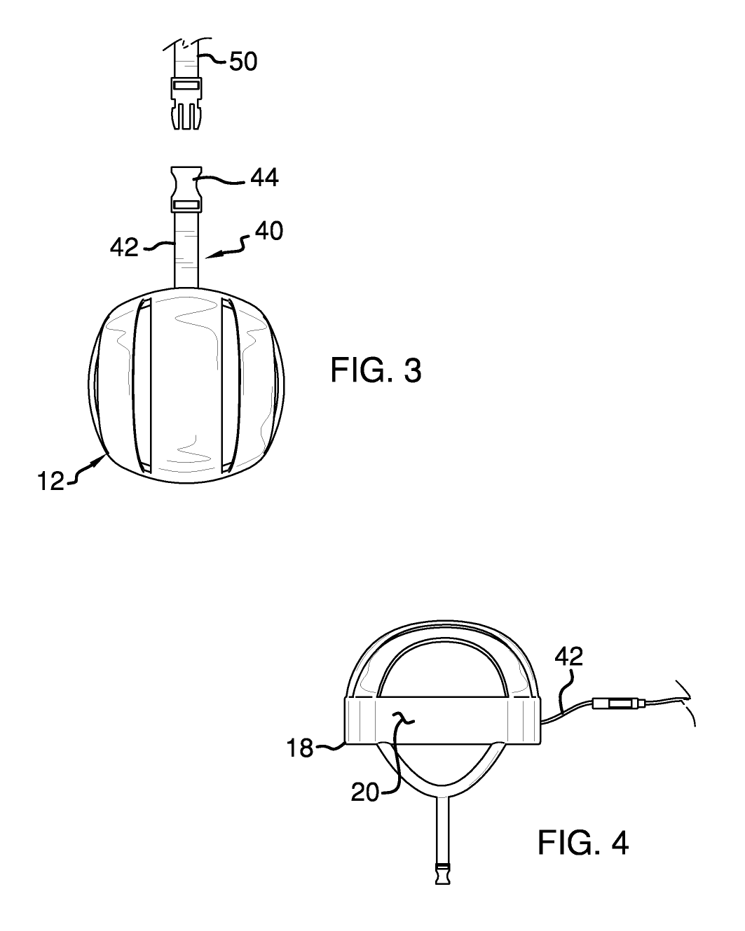

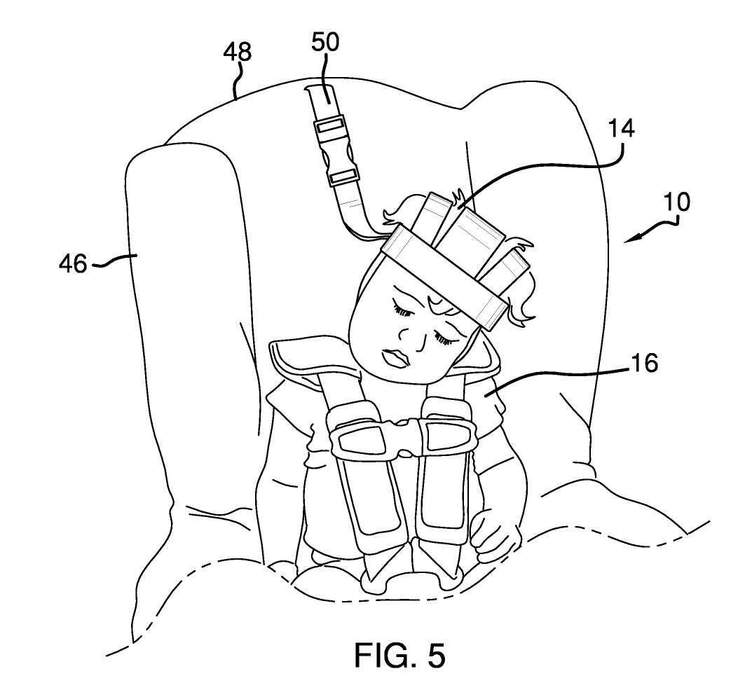

With reference now to the drawings, and in particular to FIGS. 1 through 5 thereof, a new head stabilizing device embodying the principles and concepts of an embodiment of the disclosure and generally designated by the reference numeral 10 will be described.

As best illustrated in FIGS. 1 through 5, the child head stabilizing system 10 generally comprises a helmet 12 that is configured to receive and be positioned on a head 14 of a child 16. The child 14 would typically be less than 10 years of age. The helmet 12 comprises a loop 18 that is a continuous and closed loop having an outer surface 20, an inner surface 22, an upper edge 24 and a lower edge 26. The loop 18 is configured to be positioned around the head 14 of a child 16. The loop 18 is comprised of a flexible material which may include a plastic, cloth, elastomeric or leather material. A plurality of bands 28 is provided and each has a first end 30 and a second end 32. Each of the first 30 and second 32 ends of each of the bands 28 is attached to the upper edge 24. Each of the bands 28 traverses the loop 18 in an arcuate shape above a plane of the upper edge 24. The bands 28 are comprised of a flexible material as well and the bands 28 and the loop 18 may be of a unitary construction. Each of the bands 28 is configured to be positionable an upper surface of the head 14. A chin strap 34 is attached to the lower edge 26 of the loop 18 and is configured to extend under a chin of the head 14. The chin strap 34 may include a pair of strap sections 36 releasably coupled together with a buckle 38.

A securing member 40 is attached to the helmet 12. The securing member 40 includes a tether portion 42 and a coupler 44. The tether portion 42 is flexible and is attached to and extends away from the helmet 12. More particularly, the tether portion 42 may be attached to the outer surface 20 of the loop 18 between the upper 24 and lower 26 edges. This positioning prevents the lifting of the loop 18 on the head 14 and also prevents pressure being placed on the chin strap 34.

A chair 46 is provided that is configured to hold the child 16. The chair 46, more particularly, may comprise a vehicle chair or a child's car seat that might be placed within a vehicle. The chair 46 has an apex 48 and includes a connector 50 that is attached to the chair 46 adjacent to the apex 48. The connector 50 is removably secured to the securing member 40 to retain the helmet within a selected distance from apex. The connector 50 and/or securing member 40 may have adjustable lengths to alter the selected distance as needed based upon the height of the child 16.

In use, the helmet 12 is placed on a child's head 14 so that the child's head 14 is secured to the chair 46. If the child 16 falls asleep, the child's head 14 will be supported such that the child's neck is not hurt by the child's head 14 being angled severely with respect to the child's body.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A head stabilizing system configured to stabilize a child's head when the child is sleeping, said system comprising:
a helmet being configured to receive and be positioned on a head of a child wherein said helmet comprises
a loop being a continuous and closed loop having an outer surface, an inner surface, an upper edge and a lower edge, said loop being configured to be positioned around a head of a child,
a plurality of bands each having a first end and a second end, each of said first and second ends of each of said bands being attached to said upper edge, wherein each of said bands traverse said loop in an arcuate shape above a plane of said upper edge, each of said bands being configured to being positionable over an upper surface of the head, said plurality of bands being parallel to each other and extending between a front portion and a rear portion of said loop wherein adjacently positioned bands define an associated slit therebetween;
a securing member being attached to said helmet; and
a chair configured to hold the child, said chair having an apex, a connector being attached to said chair adjacent to said apex and being removably secured to said securing member to retain said helmet within a selected distance from apex.

2. The system according to claim 1, wherein said helmet further comprises
a chin strap being attached to said lower edge of said loop and being configured to extend under a chin of the head.

3. The system according to claim 1, wherein said securing member includes a tether portion and a coupler, said tether being attached to and extending away from said helmet.

4. A head stabilizing system configured to stabilize a child's head when the child is sleeping, said system comprising:
a helmet being configured to receive and be positioned on a head of a child, said helmet comprising:
a loop being a continuous and closed loop having an outer surface, an inner surface, an upper edge and a lower edge, said loop being configured to be positioned around a head of a child, said loop being comprised of a flexible material;
a plurality of bands each having a first end and a second end, each of said first and second ends of each of said bands being attached to said upper edge, wherein each of said bands traverse said loop in an arcuate shape above a plane of said upper edge, each of said bands being configured to being positionable over an upper surface of the head, said plurality of bands being parallel to each other and extending between a front portion and a rear portion of said loop wherein adjacently positioned bands define an associated slit therebetween, said plurality of bands including a central band and a pair of outer bands, said central band having a width greater than a width of each of said outer bands;
a chin strap being attached to said lower edge of said loop and being configured to extend under a chin of the head;
a securing member being attached to said helmet, said securing member including a tether portion and a coupler, said tether being attached to and extending away from said helmet, said tether being attached to said outer surface of said loop; and
a chair configured to hold the child, said chair having an apex, a connector being attached to said chair adjacent to said apex and being removably secured to said securing member to retain said helmet within a selected distance from apex.
